(19) United States
(12) Patent Application Publication
(10) Pub. No.: US 2026/0133373 A1
(43) Pub. Date: May 14, 2026

(54) OPTICAL FIBER CLIP AND OPTICAL FIBER ADAPTER

(71) Applicants: DONGGUAN XUNTAO ELECTRONIC CO., LTD., Dongguan City (CN); Dongguan Luxshare Technologies Co., Ltd, Dongguan City (CN)

(72) Inventors: Chunghsin FU, Dongguan City (CN); Minsheng KAO, Dongguan City (CN); Yitseng LIN, Dongguan City (CN); Chienwen LU, Dongguan City (CN)

(73) Assignees: DONGGUAN XUNTAO ELECTRONIC CO., LTD, Dongguan City (CN); Dongguan Luxshare Technologies Co., Ltd, Dongguan City (CN)

(21) Appl. No.: 19/024,378

(22) Filed: Jan. 16, 2025

(30) Foreign Application Priority Data
Nov. 11, 2024 (CN) 202411605324.8

(51) Int. Cl. G02B 6/38

(52) U.S. Cl. CPC G02B 6/3879; G02B 6/3825

(57) ABSTRACT

An optical fiber clip includes an inner connection portion. The inner connection portion includes an inner connection frame and a locking arm. An inner connection groove formed in the inner connection frame is enclosed by walls of the inner connection frame, and the inner connection frame is capable of being inserted into a housing of an optical module in a first direction. The locking arm extends in the first direction, and a locking protrusion is disposed on a side of the locking arm facing away from the inner connection groove. When the inner connection frame is inserted into the housing, the locking protrusion abuts against an inner wall of the housing in a second direction, and the second direction is perpendicular to the first direction. The optical fiber adapter includes the optical fiber clip described above.

### CROSS-REFERENCE TO RELATED APPLICATION

This application claims priority to Chinese Patent Application No. 202411605324.8 filed Nov. 11, 2024, the disclosure of which is incorporated herein by reference in its entirety.

### TECHNICAL FIELD

The present disclosure relates to the technical field of optical communication, and for example, to an optical fiber clip and an optical fiber adapter.

### BACKGROUND

An optical fiber adapter in an optical module is configured to fixedly couple an external optical fiber to an internal optical fiber. The optical fiber adapter includes an optical fiber clip, an optical fiber plug, a fixing member and a pin. The optical fiber adapter is assembled in a housing of the optical module through the optical fiber clip. The internal optical fiber is mounted on the optical fiber plug. The optical fiber plug is fixedly mounted on the optical fiber clip. The fixing member is configured to position and fix the optical fiber plug and the pin. The optical fiber clip is configured to fixedly couple the external optical fiber to the internal optical fiber on the optical fiber plug.

An existing optical fiber clip has an assembly gap when being mounted within the housing of the optical module due to its own manufacturing tolerance or assembly tolerance. When the assembly gap is too large, the optical fiber clip is easy to generate a relatively large amplitude of shaking in the housing of the optical module, so that the shaking occurs after the external optical fiber is inserted into the optical fiber clip, thereby causing poor coupling and conduction between the external optical fiber in the optical module and the internal optical fiber in the optical module.

### SUMMARY

The present disclosure provides an optical fiber clip and an optical fiber adapter, so that the optical fiber clip can be assembled stably and reliably.

The present disclosure adopts the following technical solutions.

An optical fiber clip includes an inner connection portion. The inner portion includes an inner connection frame and a locking arm. An inner connection groove formed in the inner connection frame is enclosed by walls of the inner connection frame, and the inner connection frame is capable of being inserted into a housing of an optical module in a first direction. The locking arm extends in the first direction, and a locking protrusion is disposed on a side of the locking arm facing away from the inner connection groove. When the inner connection frame is inserted into the housing, the locking protrusion abuts against an inner wall of the housing in a second direction. The second direction is perpendicular to the first direction.

In an embodiment, one end of the inner connection frame facing towards a groove opening of the inner connection groove is provided with an inner avoidance groove, the inner avoidance groove penetrates through to a groove wall of the inner connection groove, the inner connection groove is in communication with an exterior through the inner avoidance groove, and the locking arm is disposed at a groove bottom of the inner avoidance groove.

In an embodiment, two inner avoidance grooves are provided, the two inner avoidance grooves are located on two opposite sides of the inner connection groove, and one locking arm is disposed in each inner avoidance groove of the two inner avoidance grooves.

In an embodiment, an interference convex rib is disposed on a side of the locking arm facing towards the inner connection groove.

In an embodiment, the optical fiber clip further includes an outer connection portion connected to the inner connection portion, an outer wall of the outer connection portion is provided with a mounting-clamping block, and the mounting-clamping block is configured to be mounted and clamped into a mounting-clamping groove of the housing

An optical fiber adapter includes an optical fiber plug and the optical fiber clip described above, and the optical fiber plug is inserted into the inner connection groove.

In an embodiment, an end of the optical fiber plug facing away from the optical fiber clip is provided with a first sinking groove, a groove bottom of the first sinking groove) is provided with a second sinking groove, a groove wall of the second sinking groove is provided with multiple penetration grooves side by side, a groove bottom of the second sinking groove is provided with multiple penetration holes side by side, the multiple penetration grooves extend in the first direction, one end of a penetration groove of the multiple penetration grooves penetrates through to the groove bottom of the first sinking groove, the other end of the penetration groove of the multiple penetration grooves penetrates through to the groove bottom of the second sinking groove, and the multiple penetration grooves and the multiple penetration holes are directly opposite to each other in one-to-one correspondence.

In an embodiment, the optical fiber adapter further includes a pin. The optical fiber plug is provided with a connection hole, the optical fiber clip further includes an outer connection portion connected to the inner connection portion, one end of the outer connection portion facing away from the inner connection portion is provided with an outer connection groove, the pin is disposed to penetrate through the connection hole, and one end of the pin extends into the outer connection groove.

In an embodiment, the optical fiber adapter further includes a fixing member. The fixing member is disposed on a side of the optical fiber plug facing away from the optical fiber clip, the fixing member is provided with a clamping hole, and the pin is clamped in the clamping hole.

In an embodiment, the fixing member has a frame-shaped structure, a wall plate of the fixing member facing towards the optical fiber plug is provided with the clamping hole and a channel hole in communication with the clamping hole, a spacing between hole walls on two sides of the channel hole is gradually increased in a direction facing away from the clamping hole, the pin includes a first connection segment, an intermediate segment and a second connection segment which are coaxially connected in sequence, a diameter of the intermediate segment is less than a diameter of the first connection segment and a diameter of the second connection segment, the first connection segment is capable of penetrating through the channel hole, and the intermediate segment is capable of moving into the clamping hole from the channel hole. When the intermediate segment is located in the clamping hole, the wall plate of the fixing member facing towards the optical fiber plug is sandwiched between the first connection segment and the second connection segment.

### BRIEF DESCRIPTION OF THE DRAWINGS

FIG. 1 is a schematic structural diagram of one positional orientation of an optical fiber clip according to an embodiment of the present disclosure;

FIG. 2 is a schematic structural diagram of another positional orientation of an optical fiber clip according to an embodiment of the present disclosure;

FIG. 3 is a schematic structural diagram of another optical fiber clip according to an embodiment of the present disclosure;

FIG. 4 is a schematic structural diagram of the cooperation between an optical fiber clip and an optical fiber plug according to an embodiment of the present disclosure;

FIG. 5 is a schematic structural diagram of one positional orientation of an optical fiber plug according to an embodiment of the present disclosure;

FIG. 6 is a schematic structural diagram of another positional orientation of an optical fiber plug according to an embodiment of the present disclosure;

FIG. 7 is a schematic structural diagram of an optical fiber adapter being mounted in a housing of an optical module according to an embodiment of the present disclosure;

FIG. 8 is a schematic structural diagram of an optical fiber adapter according to an embodiment of the present disclosure;

FIG. 9 is a schematic structural diagram of a fixing member according to an embodiment of the present disclosure; and

FIG. 10 is a schematic structural diagram of a pin according to an embodiment of the present disclosure.

### LIST OF REFERENCE NUMBERS

100 housing
1 optical fiber clip
11 inner connection portion
111 inner connection frame
1111 inner connection groove
1112 inner avoidance groove
112 locking arm
1121 locking protrusion
1122 interference convex rib
12 outer connection portion
121 outer connection frame
1211 outer connection groove
1212 outer avoidance groove
1213 mounting-clamping block
122 gripping arm
2 optical fiber plug
21 insertion portion
22 positioning portion
23 first sinking groove
24 second sinking groove
25 penetration groove
26 penetration hole
27 connection hole
3 pin
31 first connection segment
32 intermediate segment
33 second connection segment
4 fixing member
41 clamping hole
42 channel hole

### DETAILED DESCRIPTION

Embodiments of the present disclosure will be described in detail below, examples of the described embodiments are shown in the accompanying drawings, where same or similar reference numerals refer to same or similar parts or parts having same or similar functions throughout. The embodiments described below with reference to the accompanying drawings are exemplary, are intended to explain the present disclosure, and are not be construed as limiting the present disclosure.

In the description of the present disclosure, unless otherwise expressly specified and limited, the term “connected to each other”, “connected”, or “fixed” is to be construed in a broad sense, for example, as securely connected, or detachably connected; mechanically connected or electrically connected; directly connected to each other, indirectly connected to each other via an intermediary, internal connection between two elements, or interaction between two elements. For those of ordinary skill in the art, specific meanings of the preceding terms in the present disclosure may be understood based on specific situations.

In the description of the present disclosure, unless otherwise expressly specified and limited, a first feature being “on” or “under” a second feature may include the first feature and the second feature being in direct contact, or may include the first feature and the second feature not being in direct contact but being in contact with each other through an additional feature therebetween. Moreover, the first feature being “on”, “above” or “over” the second feature includes the first feature being directly on, above or over and obliquely on, above or over the second feature, or simply indicates that the first feature is at a higher level than the second feature. The first feature being “under”, “below” or “underneath” the second feature includes the first feature being directly under, below or underneath and obliquely under, below or underneath the second feature, or simply represents that the first feature is at a lower level than the second feature.

The technical solutions of the present disclosure are further explained below in conjunction with the accompanying drawings and the specific embodiments.

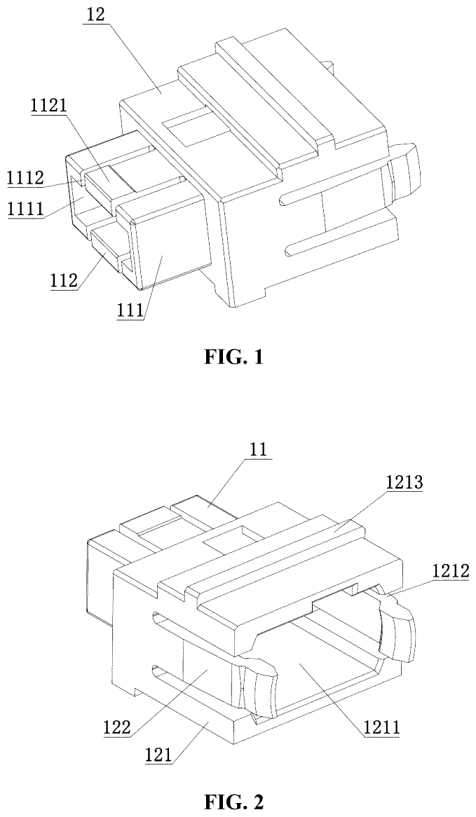

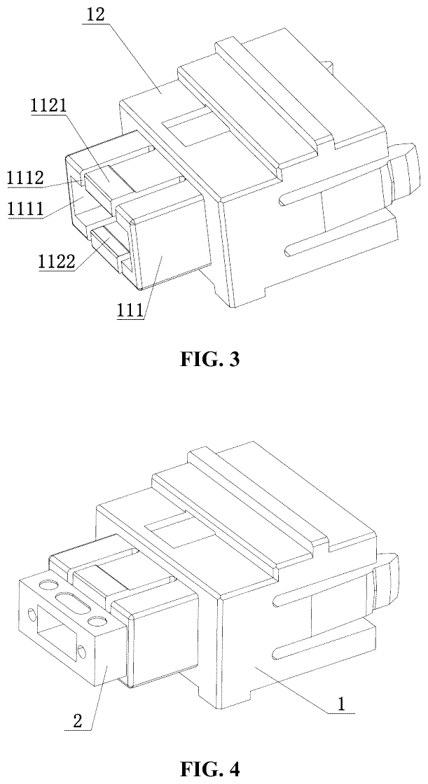

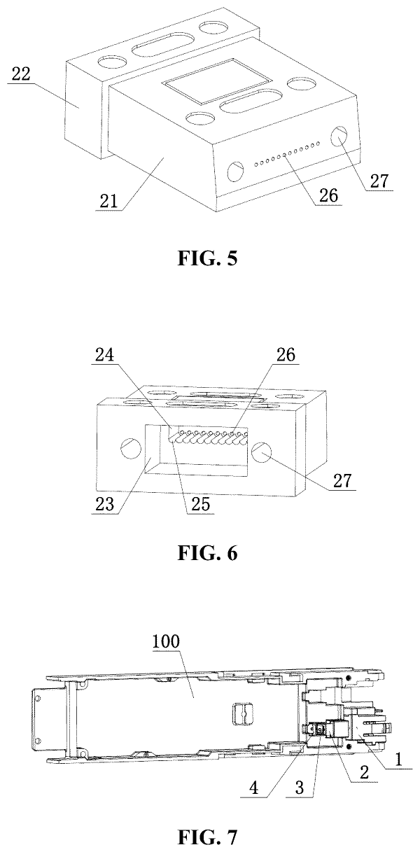

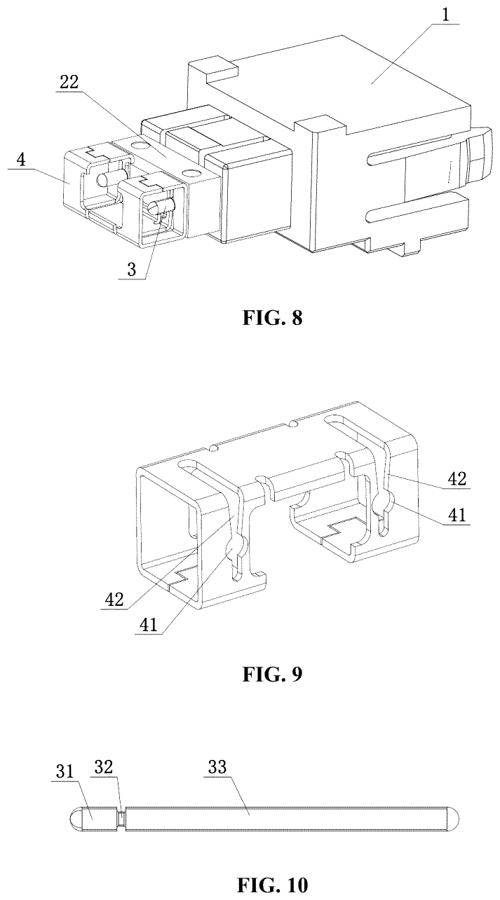

As shown in FIGS. 1 to 10, the present disclosure provides an optical fiber clip 1. The optical fiber clip 1 includes an inner connection portion 11. The inner connection portion 11 includes an inner connection frame 111 and a locking arm 112. An inner connection groove 1111 formed in the inner connection frame 111 is enclosed by walls of the inner connection frame 111, and the inner connection frame 111 is capable of being inserted into a housing 100 of an optical module in a first direction. The locking arm 112 extends in the first direction, and a locking protrusion 1121 is disposed on a side of the locking arm 112 facing away from the inner connection groove 1111. When the inner connection frame 111 is inserted into the housing 100, the locking protrusion 1121 abuts against an inner wall of the housing 100 in a second direction. The second direction is perpendicular to the first direction.

In the present disclosure, the inner connection frame 111 in the inner connection portion 11 of the optical fiber clip 1 is in cooperation with the locking arm 112 in the inner connection portion 11 of the optical fiber clip 1. The inner connection frame 111 is provided to ensure that the optical fiber clip 1 can be stably inserted into the housing 100 of the optical module in the first direction. Moreover, after the insertion is completed, the locking arm 112 abuts against the inner wall of the housing 100 in the second direction perpendicular to the first direction through the locking protrusion head 1121 on the locking arm 112, so that when the optical fiber clip 1 is inserted into the housing 100 of the optical module, the shaking does not occur, thereby ensuring the reliability and stability of coupling and conduction between an external optical fiber in the optical module and an internal optical fiber in the optical module.

In some embodiments, one end of the inner connection frame 111 facing towards a groove opening of the inner connection groove 1111 is provided with an inner avoidance groove 1112. The inner avoidance groove 1112 penetrates through to a groove wall of the inner connection groove 1111. The inner connection groove 1111 is in communication with external environment through the inner avoidance groove 1112. The locking arm 112 is disposed at a groove bottom of the inner avoidance groove 1112. With the above-described arrangement, the overall structure of the inner connection portion 11 is more compact, and thus the locking arm 112 has the larger elastic deformation space.

More specifically, two inner avoidance grooves 1112 are provided, the two inner avoidance grooves 1112 are located on two opposite sides of the inner connection groove 1111, and one locking arm 112 is disposed in each inner avoidance groove of the two inner avoidance grooves 1112. The two locking arms 112 are cooperated with each other, so that the abutting and locking effect is better, and moreover, the two locking arms 112 are located on two opposite sides of the inner connection groove 1111, so that the force applied to the inner connection portion 11 is balanced when the inner connection portion 11 is inserted into the housing 100.

In this embodiment, the locking protrusion 1121 is in a long strip shape, extends in a third direction, and is located at one end of the locking arm 112 facing towards a groove opening of the inner avoidance groove 1112, and the first direction, the second direction and the third direction are perpendicular to each other, thereby making the abutting and locking more stable and reliable.

In another embodiment, an interference convex rib 1122 is disposed on a side of the locking arm 112 facing towards the inner connection groove 1111. The interference convex rib 1122 is provided so that when an optical fiber plug 2 is inserted into the inner connection groove 1111, the optical fiber plug 2 is subject to an abutting force of the interference convex rib 1122, and thus the insertion is more reliable.

The interference convex rib 1122 may specifically be in a long strip shape and extend in the third direction.

Specifically, the optical fiber clip 1 further includes an outer connection portion 12 connected to the inner connection portion 11. One end of the outer connection portion 12 facing away from the inner connection portion 11 is provided with an outer connection groove 1211. The outer connection groove 1211 is configured to accommodate the plug of the external optical fiber, so that the external optical fiber can be reliably and stably connected to the internal optical fiber.

More specifically, the outer connection portion 12 includes an outer connection frame 121 and a gripping arm 122. An outer connection groove 1211 formed in the outer connection frame 121 is enclosed by walls of the outer connection frame 121. The gripping arm 122 extends in the first direction. When the plug of the external optical fiber is inserted into the outer connection groove 1211, the gripping arm 122 locks the plug through abutting against a side wall of the plug, thereby further ensuring that the external optical fiber is reliably and stably connected to the internal optical fiber.

More specifically, one end of the outer connection frame 121 facing towards a groove opening of the outer connection groove 1211 is provided with an outer avoidance groove 1212. The outer avoidance groove 1212 penetrates through to a groove wall of the outer connection groove 1211. The outer connection groove 1211 is in communication with the external environment through the outer avoidance groove 1212. The gripping arm 122 is disposed at a groove bottom of the outer avoidance groove 1212.

In this embodiment, the inner connection portion 11 and the outer connection portion 12 are integrally formed. Two outer avoidance grooves 1212 are disposed on the outer connection portion 12, and the two outer avoidance grooves 1212 are located on two opposite sides of the out connection groove 1211, and one gripping arm 122 is disposed in each outer avoidance groove 1212. The two gripping arms 122 are cooperated with each other, so that the plug of the external optical fiber can be clamped and locked more securely, and the force applied to the plug of the external optical fiber is balanced.

Specifically, an outer wall of the outer connection portion 12 is provided with a mounting-clamping block 1213, and the mounting-clamping block 1213 is configured to be mounted and clamped into a mounting-clamping groove of the housing 100. With the above-described arrangement, the optical fiber clip 1 can be reliably mounted in the housing 100 of the optical module.

In this embodiment, the mounting-clamping block 1213 is disposed on an outer wall of the outer connection frame 121, is in a long strip shape, and extends in the third direction.

The present disclosure further provides an optical fiber adapter, the optical fiber adapter includes an optical fiber plug 2 and the optical fiber clip 1 described above, and the optical fiber plug 2 is inserted into the inner connection groove 1111.

In the optical fiber adapter of the present disclosure, the inner connection frame 111 in the inner connection portion 11 of the optical fiber clip 1 is in cooperation with the locking arm 112 in the inner connection portion 11 of the optical fiber clip 1. The inner connection frame 111 is provided to ensure that the optical fiber clip 1 can be stably inserted into the housing 100 of the optical module in the first direction. Moreover, after the insertion is completed, the locking arm 112 abuts against the inner wall of the housing 100 in the second direction perpendicular to the first direction through the locking protrusion head 1121 on the locking arm 112, so that when the optical fiber clip 1 is inserted into the housing 100 of the optical module, the shaking does not occur, thereby ensuring the reliability and stability of coupling and conduction between the external optical fiber in the optical module and the internal optical fiber in the optical module.

In some embodiments, the optical fiber plug 2 includes an insertion portion 21 and a positioning portion 22 connected to each other. The insertion portion 21 is inserted into the inner connection groove 1111. The positioning portion 22 abuts against the inner connection frame 111. With the above-described arrangement, the insertion and positioning of the optical fiber plug 2 are more accurate.

More specifically, one end of the optical fiber plug 2 facing away from the optical fiber clip 1 is provided with a first sinking groove 23. A groove bottom of the first sinking groove 23 is provided with a second sinking groove 24. A groove wall of the second sinking groove 24 is provided with multiple penetration grooves 25 side by side. A groove bottom of the second sinking groove 24 is provided with multiple penetration holes 26 side by side. The multiple penetration grooves 25 extend in the first direction. One end of a penetration groove of the multiple penetration grooves 25 penetrates through to the groove bottom of the first sinking groove 23, and the other end of the penetration groove of the multiple penetration grooves 25 penetrates through to the groove bottom of the second sinking groove 24. The multiple penetration grooves 25 and the multiple penetration holes 26 are directly opposite to each other in one-to-one correspondence. With the above-described arrangement, the internal optical fiber can be more reliably assembled with the optical fiber plug 2.

More specifically, the optical fiber adapter further includes a pin 3. The optical fiber plug 2 is provided with a connection hole 27. The pin 3 is disposed to penetrate into the connection hole 27, and one end of the pin 3 extends into the outer connection groove 1211. The pin 3 can be inserted into the plug of the external optical fiber in alignment, so that the external optical fiber can be assembled with the optical fiber adapter more accurately.

In this embodiment, the multiple penetration grooves 25 are disposed side by side in the third direction, and the multiple penetration holes 26 are disposed side by side in the third direction. Two pins 3 are provided, and the two pins 3 extend in the first direction. The multiple penetration holes 26 are located between the two pins 3 in the third direction.

In some embodiments, the optical fiber adapter further includes a fixing member 4. The fixing member 4 is disposed on a side of the optical fiber plug 2 facing away from the optical fiber clip 1, the fixing member 4 is provided with a clamping hole 41, and the pin 3 is clamped in the clamping hole 41. With the above-described arrangement, the optical fiber plug 2 and the pin 3 can be positioned and fixed more accurately.

More specifically, the fixing member 4 has a frame-shaped structure. A wall plate of the fixing member 4 facing towards the optical fiber plug 2 is provided with the clamping hole 41 and a channel hole 42 in communication with the clamping hole 41. A spacing between hole walls on two sides of the channel hole 42 is gradually increased in a direction facing away from the clamping hole 41. The pin 3 includes a first connection segment 31, an intermediate segment 32 and a second connection segment 33 which are coaxially connected in sequence. A diameter of the intermediate segment 32 is less than each of a diameter of the first connection segment 31 and a diameter of the second connection segment 33. The first connection segment 31 is capable of penetrating through the channel hole 42. The intermediate segment 32 is capable of moving into the clamping hole 41 from the channel hole 42. When the intermediate segment 32 is located in the clamping hole 41, the wall plate of the fixing member 4 facing towards the optical fiber plug 2 is sandwiched between the first connection segment 31 and the second connection segment 33. With the above-described arrangement, the fixing member 4 can be conveniently and quickly assembled and disassembled with the pin 3.

In this embodiment, a length direction of the channel hole 42 is parallel to the second direction. One clamping hole 41 and one channel hole 42 are configured for each pin 3. When the pin 3 is clamped in the clamping hole 41, the first connection segment 31 is located in the fixing member 4. The fixing member 4 is provided with a threading channel in a penetrating manner in the first direction, and the threading channel is in communication with the first sinking groove 23, so that the internal optical fiber can extend into the optical fiber plug 2 through the threading channel.

Apparently, the above-described embodiments of the present disclosure are merely examples for clearly illustrating the present disclosure and are not intended to limit the embodiments of the present disclosure. Other variations or modifications in different forms may be made in light of the above description for those of ordinary skill in the art. This need not be, nor should it be exhaustive of all embodiments. Any modification, equivalent replacement, and improvement made within the spirit and the principle of the present disclosure should be included in the scope of protection of the claims of the present disclosure.

What is claimed is:

1. An optical fiber clip, comprising: an inner connection portion, wherein the inner connection portion comprises:
an inner connection frame, wherein an inner connection groove formed in the inner connection frame is enclosed by walls of the inner connection frame, and the inner connection frame is configured to be capable of being inserted into a housing of an optical module in a first direction; and
a locking arm, extending in the first direction, wherein a locking protrusion is disposed on a side of the locking arm facing away from the inner connection groove, in response to the inner connection frame is inserted into the housing, the locking protrusion abuts against an inner wall of the housing in a second direction, and the second direction is perpendicular to the first direction.

2. The optical fiber clip of claim 1, wherein one end of the inner connection frame facing towards a groove opening of the inner connection groove is provided with an inner avoidance groove, the inner avoidance groove penetrates through to a groove wall of the inner connection groove, the inner connection groove is in communication with external environment through the inner avoidance groove, and the locking arm is disposed at a groove bottom of the inner avoidance groove.

3. The optical fiber clip of claim 2, wherein two inner avoidance grooves are provided, the two inner avoidance grooves are located on two opposite sides of the inner connection groove, and one locking arm is disposed in each inner avoidance groove of the two inner avoidance grooves.

4. The optical fiber clip of claim 2, wherein an interference convex rib is disposed on a side of the locking arm facing towards the inner connection groove.

5. The optical fiber clip of claim 1, further comprising an outer connection portion connected to the inner connection portion, an outer wall of the outer connection portion is provided with a mounting-clamping block, and the mounting-clamping block is configured to be mounted and clamped into a mounting-clamping groove of the housing.

6. An optical fiber adapter, comprising: an optical fiber plug and an optical fiber clip of, wherein the optical fiber plug is inserted into the inner connection groove; and
wherein the optical fiber clip comprises an inner connection portion, and the inner connection portion comprises:
an inner connection frame, wherein an inner connection groove formed in the inner connection frame is enclosed by walls of the inner connection frame, and the inner connection frame is configured to be capable of being inserted into a housing of an optical module in a first direction; and
a locking arm, extending in the first direction, wherein a locking protrusion is disposed on a side of the locking arm facing away from the inner connection groove, in response to the inner connection frame is inserted into the housing, the locking protrusion abuts against an inner wall of the housing in a second direction, and the second direction is perpendicular to the first direction.

7. The optical fiber adapter of claim 6, wherein an end of the optical fiber plug facing away from the optical fiber clip is provided with a first sinking groove, a groove bottom of the first sinking groove is provided with a second sinking groove, a groove wall of the second sinking groove is provided with a plurality of penetration grooves side by side, a groove bottom of the second sinking groove is provided with a plurality of penetration holes side by side, the plurality of penetration grooves extend in the first direction, one end of a penetration groove of the plurality of penetration grooves penetrates through to the groove bottom of the first sinking groove, the other end of the penetration groove of the plurality of penetration grooves penetrates through to the groove bottom of the second sinking groove, and the plurality of penetration grooves and the plurality of penetration holes are directly opposite to each other in one-to-one correspondence.

8. The optical fiber adapter of claim 6, further comprising a pin, wherein the optical fiber plug is provided with a connection hole, the optical fiber clip further comprises an outer connection portion connected to the inner connection portion, one end of the outer connection portion facing away from the inner connection portion is provided with an outer connection groove, the pin is disposed to penetrate through the connection hole, and one end of the pin extends into the outer connection groove.

9. The optical fiber adapter of claim 8, further comprising a fixing member, wherein the fixing member is disposed on a side of the optical fiber plug facing away from the optical fiber clip, the fixing member is provided with a clamping hole, and the pin is clamped in the clamping hole.

10. The optical fiber adapter of claim 9, wherein the fixing member has a frame-shaped structure, a wall plate of the fixing member facing towards the optical fiber plug is provided with the clamping hole and a channel hole in communication with the clamping hole, a spacing between hole walls on two sides of the channel hole is gradually increased in a direction facing away from the clamping hole, the pin comprises a first connection segment, an intermediate segment and a second connection segment which are coaxially connected in sequence, a diameter of the intermediate segment is less than each of a diameter of the first connection segment and a diameter of the second connection segment, the first connection segment is configured to be capable of penetrating through the channel hole, the intermediate segment is configured to be capable of moving into the clamping hole from the channel hole, and in response to the intermediate segment is located in the clamping hole, the wall plate of the fixing member facing towards the optical fiber plug is sandwiched between the first connection segment and the second connection segment.

11. The optical fiber adapter of claim 6, wherein one end of the inner connection frame facing towards a groove opening of the inner connection groove is provided with an inner avoidance groove, the inner avoidance groove penetrates through to a groove wall of the inner connection groove, the inner connection groove is in communication with external environment through the inner avoidance groove, and the locking arm is disposed at a groove bottom of the inner avoidance groove.

12. The optical fiber adapter of claim 11, wherein two inner avoidance grooves are provided, the two inner avoidance grooves are located on two opposite sides of the inner connection groove, and one locking arm is disposed in each inner avoidance groove of the two inner avoidance grooves.

13. The optical fiber adapter of claim 11, wherein an interference convex rib is disposed on a side of the locking arm facing towards the inner connection groove.

14. The optical fiber adapter of claim 6, further comprising an outer connection portion connected to the inner connection portion, an outer wall of the outer connection portion is provided with a mounting-clamping block, and the mounting-clamping block is configured to be mounted and clamped into a mounting-clamping groove of the housing.

15. The optical fiber adapter of claim 11, wherein an end of the optical fiber plug facing away from the optical fiber clip is provided with a first sinking groove, a groove bottom of the first sinking groove is provided with a second sinking groove, a groove wall of the second sinking groove is provided with a plurality of penetration grooves side by side, a groove bottom of the second sinking groove is provided with a plurality of penetration holes side by side, the plurality of penetration grooves extend in the first direction, one end of a penetration groove of the plurality of penetration grooves penetrates through to the groove bottom of the first sinking groove, the other end of the penetration groove of the plurality of penetration grooves penetrates through to the groove bottom of the second sinking groove, and the plurality of penetration grooves and the plurality of penetration holes are directly opposite to each other in one-to-one correspondence.

16. The optical fiber adapter of claim 12, wherein an end of the optical fiber plug facing away from the optical fiber clip is provided with a first sinking groove, a groove bottom of the first sinking groove is provided with a second sinking groove, a groove wall of the second sinking groove is provided with a plurality of penetration grooves side by side, a groove bottom of the second sinking groove is provided with a plurality of penetration holes side by side, the plurality of penetration grooves extend in the first direction, one end of a penetration groove of the plurality of penetration grooves penetrates through to the groove bottom of the first sinking groove, the other end of the penetration groove of the plurality of penetration grooves penetrates through to the groove bottom of the second sinking groove, and the plurality of penetration grooves and the plurality of penetration holes are directly opposite to each other in one-to-one correspondence.

17. The optical fiber adapter of claim 13, wherein an end of the optical fiber plug facing away from the optical fiber clip is provided with a first sinking groove, a groove bottom of the first sinking groove is provided with a second sinking groove, a groove wall of the second sinking groove is provided with a plurality of penetration grooves side by side, a groove bottom of the second sinking groove is provided with a plurality of penetration holes side by side, the plurality of penetration grooves extend in the first direction, one end of a penetration groove of the plurality of penetration grooves penetrates through to the groove bottom of the first sinking groove, the other end of the penetration groove of the plurality of penetration grooves penetrates through to the groove bottom of the second sinking groove, and the plurality of penetration grooves and the plurality of penetration holes are directly opposite to each other in one-to-one correspondence.

18. The optical fiber adapter of claim 14, wherein an end of the optical fiber plug facing away from the optical fiber clip is provided with a first sinking groove, a groove bottom of the first sinking groove is provided with a second sinking groove, a groove wall of the second sinking groove is provided with a plurality of penetration grooves side by side, a groove bottom of the second sinking groove is provided with a plurality of penetration holes side by side, the plurality of penetration grooves extend in the first direction, one end of a penetration groove of the plurality of penetration grooves penetrates through to the groove bottom of the first sinking groove, the other end of the penetration groove of the plurality of penetration grooves penetrates through to the groove bottom of the second sinking groove, and the plurality of penetration grooves and the plurality of penetration holes are directly opposite to each other in one-to-one correspondence.

19. The optical fiber adapter of claim 11, further comprising a pin, wherein the optical fiber plug is provided with a connection hole, the optical fiber clip further comprises an outer connection portion connected to the inner connection portion, one end of the outer connection portion facing away from the inner connection portion is provided with an outer connection groove, the pin is disposed to penetrate through the connection hole, and one end of the pin extends into the outer connection groove.

20. The optical fiber adapter of claim 12, further comprising a pin, wherein the optical fiber plug is provided with a connection hole, the optical fiber clip further comprises an outer connection portion connected to the inner connection portion, one end of the outer connection portion facing away from the inner connection portion is provided with an outer connection groove, the pin is disposed to penetrate through the connection hole, and one end of the pin extends into the outer connection groove.
